(19) United States
(12) Patent Application Publication
(10) Pub. No.: US 2015/0158228 A1
(43) Pub. Date: Jun. 11, 2015

(54) LABORATORY EXTRUDER

(71) Applicants: Boudewijn Jan Robert Scholtens, Echt (NL); Matheus Pieter Quaedflieg, Echt (NL); Leonardus Wilhelmus Guillaume Rijks, Echt (NL); Robert Joseph Maria Coumans, Echt (NL)

(72) Inventors: Boudewijn Jan Robert Scholtens, Echt (NL); Matheus Pieter Quaedflieg, Echt (NL); Leonardus Wilhelmus Guillaume Rijks, Echt (NL); Robert Joseph Maria Coumans, Echt (NL)

(73) Assignee: DSM IP ASSETS B.V., Heerlen (NL)

(21) Appl. No.: 14/241,593

(22) PCT Filed: Aug. 29, 2012
(86) PCT No.: PCT/EP2012/066767

§ 371 Date: Jun. 5, 2014

(30) Foreign Application Priority Data
Aug. 29, 2011 (EP) 11179210.7

(51) Int. Cl. B29C 47/00

(52) U.S. Cl. CPC B29C 47/0002; B29L 2031/00

(57) ABSTRACT

The invention relates to an extruder (1) for processing relatively small quantities of pharmaceutical and/or biomedical materials, which extruder (1) comprises an extruder frame (7), a barrel (9, 10), a pair of extruder screws (3), and a drive for rotating the extruder screws (3), wherein the barrel (9, 10) is formed by a pair of separable housing blocks that are positioned in a closed position against each other during processing, each housing block having a barrel liner (13, 15), wherein in the closed position of the pair of separable housing blocks the barrel liners define an interior volume, a feed opening (30), a discharge opening (45) and an opening (31a, 33a) for receiving the pair of extruder screws (3) in the interior volume.

The embodiments described herein relate to an extruder for processing relatively small quantities of material on laboratory scale, preferably of pharmaceutical and/or biomedical materials, which extruder comprises an extruder frame, a barrel, at least one extruder screw, and a drive for rotating the at least one extruder screw, wherein the barrel is formed by a pair of separable housing blocks that are positioned in a closed position against each other during processing, wherein in the closed position the pair of separable housing blocks define an interior volume, a feed opening, a discharge opening and an opening for receiving the at least one extruder screw in the interior volume.

An extruder for melting and mixing materials available only in small amounts is known from WO2006077147. This publication describes an extruder having a variable effective volume, resulting from the presence of at least one recirculation channel, at least two recirculation exits, and a valve system to direct material through the recirculation channel and exits, and/or the extruder discharge. Said extruder can be operated (semi) batch-wise or continuously. Extruders of this type may be particularly applied in a laboratory environment for processing experimental material or formulation, which are only available in small quantities, into test samples.

This known extruder demonstrates excellent performance for processing relatively small quantities of material. However, if between batches at least the barrel needs to be cleaned to prevent cross-contamination, which is a prerequisite in processing e.g. pharmaceutical or biomedical materials or compositions, the total effective processing time of the known extruder for one batch is relatively long, as thorough cleaning is very difficult and during cleaning the extruder cannot be used. The same applies, although with less impact on effective processing time, for at least two consecutive continuous processing runs, between which runs no cross-contamination may occur. As a result, the use efficiency, or effective capacity of the known extruder for different batches/different continuous runs, i.e. the total number of processed samples per unit of time, is relatively low.

It is therefore an object of the present invention to provide an extruder that addresses one or more of the above mentioned issues.

In the extruder according to an embodiment of the present invention each housing block comprises a barrel base and a barrel liner, wherein the barrel base is connected to the extruder frame, to which barrel base a barrel liner is detachably mountable, and wherein the barrel liner is designed such that at least a part of one outer wall of the barrel liner at least partly covers an outer wall of the barrel base as the barrel liner is mounted to the barrel base.

The barrel base and barrel liner can be mounted to each other in a quick, easy and operator friendly way as the outer walls of the barrel liner and the barrel base may for example slide over each other during mounting and for example be held in place by gravity or by fasteners. Further, by sliding the outer walls over each other the barrel liner and the barrel base are automatically aligned to each other in one direction. By using fasteners like for example bolts the barrel liner used for processing a first batch of pharmaceutical or biomedical materials can be exchanged in a fast and reliable and reproducible manner for another barrel liner, of the same or different design, such that the extruder can be used for processing a second batch of material, with minimal delay and minimal risks of cross-contamination. Cross-contamination is also limited by at the same time exchange extruder screws. Examples of fasteners are bolts, screws, hooks, knobs, interlocking members, nails, and frames. In fact it is the pair of barrel liners that in the closed position of the housing blocks define interior volume, feed opening, discharge opening and opening for receiving the at least one extruder screw in the interior volume. It should be mentioned that each of the feed opening, discharge opening, and opening for receiving the at least one extruder screws in the interior volume may be arranged in one of the barrel liners or in an interface between the barrel liners. For example, it was found that a discharger opening may advantageously be arranged in one barrel liner only whereas the opening for receiving the at least one extruder screws in the interior volume advantageously was arranged in the interface between the barrel liners (such as partially in both barrel liners. A different design of the barrel liner means that its basic dimensions for connecting to the barrel base of the housing block remain unchanged, but that one or more modifications have been made to for example interior volume, feed opening, or discharge opening. As the delay for changing barrel liners is small, the extruder can be used very efficiently and has a relatively high effective capacity; meaning the extruder is able to process a large number of samples in a certain period. As the quantities of materials to be processed with the extruder according to the present invention may be relatively small, and may contain very active ingredients, the effects of cross-contamination may be relatively detrimental for the samples to be produced. The extruder according to the invention can be operated in compliance with relevant industry practice and standards, like GMP. The barrel liner, or more particularly the set of barrel liners, may be cleaned thoroughly in parallel with the next extrusion experiments by various methods such as brushing with a soap solution, ultrasonic cleaning and/or sterilization.

Traditionally, after extruding one sample, the whole extruder must be cleaned before extruding the next sample. In embodiments according to the present invention, after extruding one sample the used liner and extruder screw(s) are replaced with a clean liner (and extruder screw(s)), where after the extruder is ready for the next sample. The used liner may then be cleaned while using the extruder or at a later time, but it should be noticed that the cleaning of the liner is not limiting for the continued use of the extruder.

| | Embodiment of the | Embodiment of the |
|---|---|---|
| Traditional extruder: | present invention* | present invention** |
| Extrude material 1 | Extrude material 1 | Extrude material 1 |
| ↓ | ↓ | ↓ |
| Clean extruder | Exchange liner set 1 | Remove liner to suitable |
| ↓ | with liner set 2 | cleaning facility |
| | ↓ | ↓ |
| Extrude material 2 | Extrude material 2 | Clean liner in suitable |
| ↓ | ↓ | cleaning facility |
| | | ↓ |
| Clean extruder | Exchange liner set 2 with | Optionally sterilize liner |
| | liner set 3 (or cleaned | ↓ |
| | liner 1) | Refit liner |
| | | ↓ |
| | | Extrude material 2 |

*When using this embodiment of the present invention, cleaning of exchanged liners and extruder screw(s) can be conducted simultaneously with extrusion and hence is not limiting to the number of samples, which can be extruded in a fixed time.
**When using this embodiment of the present invention, cleaning may be conducted away from the extruder. This allows for one or more advantages such as 1) the area around the extruder may be kept clean as no cleaning of the liner is required at the position of the extruder; 2) the cleaning may involve more harsh conditions of the cleaning - for example involving hot water or volatile organic solvent - without compromising safety - for example by conducting the cleaning in a fume cupboard; 3) cleaning of the parts separated from the extruder is much faster, easier and more thorough than cleaning parts connected to the extruder; 4) sterilization is easily achievable, as only the liner, hopper and extrusion screws need to be sterilized whereafter the sterilized pieces may be mounted on the housing.

The method of operating the extruder of this embodiment may also involve removing of hopper and extruder screw(s) from the housing blocks as well as cleaning, sterilizing and attach the cleaned hopper and extruder screw(s) in/to the housing blocks. It should be understood that one or more of the barrel liners, the hopper, the extruder screw(s) may be replaced by other corresponding barrel liners, hopper and extruder screw(s) with same or different geometry in this process if this is desired due to time constrains or change in desired extrusion process.

The embodiments of an extruder disclosed herein may be used for example in a laboratory environment for processing relatively small quantities of costly and/or active materials or compounds such as pharmaceutical and/or biomedical materials or formulations (here understood to be a composition comprising a pharmaceutical and/or biomedical active ingredient and a thermoplastic polymer matrix). As exchanging the barrel liners for processing different (types of) batches can be done relatively fast, more experiments can be run in the same time frame. While a first pair of barrel liners and optionally other parts are cleaned and/or sterilized, the extruder can meanwhile be used by applying a second pair of barrel liners (and auxiliary parts if necessary). In this way the disclosed extruders can also be operated very flexibly.

Typical extruders require large amounts of extruding material to conduct reproducible production, such as more than 500 g extruding material and often more than 1 kg extruding material. The term relatively small quantities of materials relates in this text to quantities less than 100 gram (g) of extruding material required to conduct reproducible production. In preferred embodiments of the invention, the extruder may reach reproducible production with less than 50, 25, 15, or even 5 g extruding material.

In another embodiment, the extruder operates at a maximum throughput of up to 300 g/hr or even 400 g/hr. However, it is preferred that the extruder operates at low throughput of extruding material, for example at throughput as low as about 50, 25, 20 or even 10 g/hr, depending on among others material viscosity, extruder screw speed, die dimensioning, etc.

In an embodiment, the barrel liner is designed such that at least a part of one outer wall of the barrel liner at least partly covers an outer wall of the barrel base when the barrel liner is mounted to the barrel base. In another embodiment, the barrel liner virtually completely covers the barrel base, resulting in the barrel liner covering the barrel base, and thus minimizing the chance that material being processed can be trapped between barrel base and barrel liner, which would otherwise be a potential source of contamination. In a preferred embodiment, an outer wall of the barrel base being at least partially covered by the barrel liner when the barrel liner is mounted to the barrel base, is flat or convex, i.e. not concave as for example the inner side of a cylinder.

In an embodiment, the barrel liner used in the extruder according to the invention is made as a single piece or unitary part, to make it better and easier to clean. In an embodiment, the barrel liner does not comprise further recesses or openings for cooling or the like, other than those indicated herein and needed for mounting and operating.

In a first embodiment of the extruder according to the present invention, the barrel liner is U-shaped, comprising two spaced apart legs that are connected to each other by a bridge part, wherein the legs of the U-shaped barrel liner are formed by two outer walls between which the barrel base is positioned at least partly as the barrel liner is mounted to the barrel base. More preferably the liner fully covers the barrel base, preventing material being processed is able to contact the barrel base.

These U-shaped configured barrel liners can easily be mounted to the barrel bases, as opposing outer walls of the barrel bases slide into the opening provided by the two other walls of the barrel liner and over the sides of the legs/outer walls of the barrel liner facing each other. Furthermore, automatic alignment of barrel liner and barrel base in two directions will occur during mounting of the U-shaped barrel liner to the barrel base. The U-shaped configured barrel liners can be demounted, and cleaned or sterilized easily and relatively quickly. In an embodiment, the U shaped barrel liner does not have any difficult accessible corners.

The barrel liners, like other relevant parts of the extruder, are preferably made from a material suited for processing pharmaceutical or biomedical material compositions and in line with industry—e.g. GMP—requirements, like a stainless steel. Parts preferably have a smooth surface with low surface roughness. This not only improves cleanability, but also improves contacting of surfaces of parts being mounted together, resulting in good heat transfer and little change of contamination.

In an embodiment, each barrel base has heating and/or cooling capability for controlling the temperature of the barrel, and thus of the material to be processed in the interior volume. In the U-shaped barrel liner the contact surface between barrel liner and barrel base is relatively large, which makes accurate control of temperature possible by means of the heating and/or cooling unit integrated in the barrel base. Having heating and/or cooling capability in only the barrel base and not the barrel liner allows for a more simple design of the liner which again leads to more affordable liners, faster change of liner (as no connections for heat transfer fluid is required) and easier cleaning of the liner.

In a second embodiment of the extruder according to the present invention, the barrel liner is detachable mountable to the barrel base by fasteners. Preferably, the fasteners comprise at least one hook and guiding and locking means for guiding and locking the hook (and hence the barrel liner relative to the barrel base) automatically and detachably.

Said hook can be positioned on the barrel base and the guiding and locking means can be positioned on a side of the barrel liner directed to the barrel base for coupling, or vice versa. The guiding may for example be arranged by a protruding member and a corresponding slit or by a frame member of the barrel liner and/or the barrel base. Locking may for example be realized by an elastic member deformable to allow passage in one direction but preventing passage in another direction without interacting with the elastic member. Other examples of guiding and locking are well known to the skilled person. By means of the hook and the locking means not only an easily detachable connection can be provided, but the guiding means for receiving and guiding the hook also aligns the barrel base relative to the barrel liner. By means of the hook and the guiding and locking means a fast, operator-friendly, reproducible and reliable coupling is provided.

The extruder according to the present invention can have different effective extruder volumes, by using different (sets of) barrel liners, for example comprising a feed opening at different locations. As feed opening, for example, the opening through which the extruder screws enter the barrel can be used; especially in case of a vertically operated extruder. To enhance feeding, such opening is preferably provided with a hopper. Feeding in such case may be by gravity only, or aided by means like a screw or ribbon. Alternatively, or in addition, a feed opening can be defined by or provided in a barrel liner at a more downstream location of the at least one screw. In such case it may be called a downstream or side feed opening. Depending on extruder lay-out and material properties, material can be fed by gravity, but is typically force fed, using for example a piston, ribbon or screw feeder. At any of such feed openings a hopper may be provided. Hopper and/or feeder are preferably provided with a cooler to prevent premature melting and sticking of material being fed; especially in case of low melting powdery materials. The cooler may for example be a water cooled member or a gas cooled member arranged between the hopper and the feed opening or the hopper itself may be cooled actively by water or gas. By means of varying the location of the feed opening, only part of the extruder screw length—downstream of the feed opening—is effectively used for melting and mixing material. Given a certain fixed internal volume and extruder screw geometry, the effective extruder volume can thus still be simply varied by exchanging barrel liners. The invention thus also relates to an extruder, wherein the feed opening is defined by at least one barrel liner, wherein the at least one barrel liner is exchangeable with at least one other barrel liner, which other barrel liner defines the feed opening at a different location. If a more downstream feed opening is used, the extruder screw design may also be adjusted. The part of the extruder screw not effectively used would not need to have conveying or mixing ability, and could for example be smooth. Also, the extruder screw can be provided with back-blocker to prevent material being fed is transported upstream instead of downstream towards the discharge opening. Examples of back-blockers are a disc or a scraper.

The effective volume of the extruder of the invention may also be adjusted by exchanging the at least one extruder screw for an extruder screw of different design, for example having different channel depth.

In a further embodiment of the extruder according to the present invention the dimensions of the interior volume of a first pair of housing blocks differs from the dimensions of a second interior volume of a second pair of housing blocks. Each of the first housing blocks comprises a barrel base and a first barrel liner and each of the second housing blocks comprises the same barrel base and a different barrel liner. Thereby the effective extruder volume (also referred to as the interior volume) of the extruder in the closed position as well as the geometry and flow path (for example with or without recirculation channel) may be varied by only changing the barrel liners and hence not having to change the whole barrel or even the full extruder.

In such case, it may be preferred to adjust the extruder screw dimensions accordingly, to retain proper melting and mixing behaviour; especially in case the extruder comprises a single extruder screw. This approach allows even larger variations in volume than the measures discussed above.

The effective extruder volume may vary widely, for example from 100 millilitre (ml) to only 1 ml. This is an important advantage of the extruder according to the invention, as such broad range of volumes is not achievable with known extruders. Typically, different extruder systems would need to be used for processing a sample amount of about 15 gram versus about 5 gram; whereas with the present invention replacement of one set of barrel liners with another additional sets of barrel liners is required since extruder screws and optionally other auxiliary parts (like a hopper) can be used in combination with the same extruder frame, drive and other equipment for a wide range of extruder volumes. Preferably, the extruder according to the invention may be provided with various barrel liners leading to an effective extruder volume of at most 90, 80, 70, 60, 50, 40, 30, 20, 10 or even 5 ml. Preferably, the extruder may be provided with various barrel liners leading to an effective volume of at least 1, 1.5, 2 or 3 ml, in view possible practical problems. In one embodiment the extruder according to the invention is provided with a barrel liner having an effective extruder volume of between about 30 and 1 ml, in other embodiments between 20 and 1.5, or between 10 and 2 ml.

With the extruder according to the present invention it is possible to extrude a small amount of material, making it possible to provide e.g. medicine containing samples, for example with controlled release properties, on small scale in a relatively cost effective manner. Micro-processing has the unique functionality that it enables to produce test-samples from only a small amounts of material, typically of less than 100, 50, 20, 10 or even 5 gram. The advantage of micro-processing over normal processing is its small scale, resulting in the consumption of less material (base material and additives), reduced processing time and more and faster evaluation. Therefore micro-processing provides the opportunity to generate more data in less time and at minimum costs as well as minimum waste per type of sample/batch processed.

In another embodiment of the extruder according to the present invention at least one barrel liner comprises at least one recirculation channel. Such recirculation channel, in combination with a valve or tap as described later, allows the extruder to be operated not only in a continuous mode, but also in a (semi-)batch mode by (partly) recycling or recirculating material being processed. The percentage recycling or recirculation can be varied between 0% (no recirculation) and 100% (complete recirculation) by directing material to either the discharge opening, or to the recirculation channel, or to both. The recirculation channel in a barrel liner has a certain fixed geometry, and also—somewhat—increases the effective extruder volume of two barrel liners in the closed position. Such recirculation channel, however, mainly serves to increase residence time of the material being processed in the extruder to enhance e.g. melting, mixing or dispersing. Because a part of the material being processed in principle remains in such channel also after discharging material from the extruder, channel dimensions are chosen such to allow proper material flow through the channel; but its volume is preferably kept as low as possible. For any given material an optimum extruder lay-out may be identified, by exchanging barrel liners having recirculation channels of different length and geometries. The recirculation channel connects via a recirculation exit to the extruder interior volume upstream of the beginning of the channel. The recirculation exit preferably connects at or somewhat downstream of the feed opening, resulting in mixing the material from the recirculation channel with material being fed to the extruder.

In a further embodiment a recirculation channel comprises at least one static mixer element. Using said static mixer element will diminish or even prevent phase separation of material being processed, and may even improve mixing and dispersing, which would otherwise not take place in a recirculation channel. Presence of a static mixer element in a recirculation channel can thus reduce residence time and/or (batch) processing time of the extruder according to the present invention considerably. Static mixer elements of various geometries are known to a skilled person, and may be selected depending on the type of material to be processed. Preferably, the static mixer element is detachably connected into the recirculation channel. This provides a flexible barrel liner, which can comprise no, or one or more static mixers of the same or different geometries. If no static mixer is needed, insert elements having no static mixing feature should replace the static mixer elements such that a normal recirculation channel or normal recirculation channel part is provided. In addition, as the static mixer elements may comprise a relatively large and complex configured internal mixing surface it is advantageous to have sufficient interchangeable static mixer elements available to prevent any delay caused by cleaning/sterilizing elements between series of runs. It is also possible to provide a disposable static mixer element.

The extruder according to the invention comprises at least one extruder screw. In one embodiment the extruder comprises one extruder screw. An extruder comprising one extruder screw is typically called a single screw extruder. An advantage of the extruder comprising one extruder screw is the freedom to not only vary extruder screw design, e.g. transporting versus mixing characteristics, depth of channel, for a given diameter; but to also vary extruder screw dimensions including diameter in combination with matching barrel liners and interior volume.

In another embodiment the extruder according to the invention comprises two extruder screws; generally referred to as a twin-screw extruder. The two extruder screws preferably co-rotate in the same direction, but counter-rotating extruder screws are also possible. The two extruder screws may be essentially cylindrical and rotate co-axially; or be a set of conical extruder screws. In a preferred embodiment of the invention, the extruder comprises a pair of conical extruder screws, because such construction is more robust for a laboratory scale extruder. The pair of extruder screws used in the extruder according to this embodiment of the invention is preferably an intermeshing pair of extruder screws for supporting good melting and mixing as well as an element of self-cleaning.

It is further possible with the extruder of the present invention to change the type of extruder screw(s) of the extruder. For example, if a new pair of barrel liners is used, having a different interior volume than the previous pair, it may be required to change the diameter or the design of the extruder screw(s) to retain proper functioning. However, it is also possible to change the extruder screw geometry for optimizing the feeding, melting, mixing and transporting properties of the extruder screws, depending on the material to be processed; or to change the effective extruder volume by varying the profile of the extruder screw, e.g. its channel depth. Furthermore, the extruder screw(s) may also be replaced for cleaning to prevent cross-contamination between materials to be extruded.

Preferably for cleaning and sterilizing purposes many components of the extruder according to the invention are made of two halves, like e.g. a cooled hopper or a die. Such halves may be complementary or identical. For example, the die comprises two halves that are positioned in a truncated cone. Further, the truncated cone is positioned in a bayonet ring to be coupled with the extruder exit. In this way on the one hand a reliable and quick coupling is obtained for coupling the die forming components and on the other hand the parts forming the die can be easily cleaned and/or sterilized. The die may be designed for making extrudate of various geometries, like a round strand, a strip or a flat film.

In addition to the above, the discharge opening may comprise a tap. The tap is preferably detachably mountable in the discharge opening for example by a bar and said tap may be operable by said bar between some positions thereof. During cleaning and/or sterilization the tap is easily removable from the barrel liner. As indicated above, such tap functions as a valve to direct material in one or two directions; which enables operating the extruder in continuous extrusion mode, or in batch- or semi-batch mode.

The invention also relates to use of the extruder according to the invention in processing material on a laboratory scale, especially material samples availably in amounts of less than 100, 50, 20, 10 or even 5 gram. Preferably, the use relates to processing pharmaceutical and/or biomedical materials and compositions in the extruder. In one embodiment, an extruder according to the invention is used for manufacturing medical products such as for example personalized medicine. This embodiment is highly advantageous, as the ability of the extruder to operate using only very small amounts of material leads to the option of preparing only small amounts of medicine formulated for one individual and on the same time only realize low amounts of waste of biologically active substances used in the medicine. Furthermore, the ease of access to sterilization of the liners, extruder screws and hopper also provides major advantages of this use of an extruder according to the invention.

The invention also relates to a method for processing material on a laboratory scale, especially material samples availably in amounts of less than 100, 50, 20, 10 or even 5 gram, with the extruder according to the invention. Preferably, the method relates to processing pharmaceutical and/or biomedical materials and compositions with the extruder according to the invention.

It is understood that any combination between different embodiments and preferred features as described herein can be made and form part of the invention, whether such combination is explicitly mentioned or not.

The invention will now be explained in more detail with reference to some exemplary embodiments shown in the appended figures, in which:

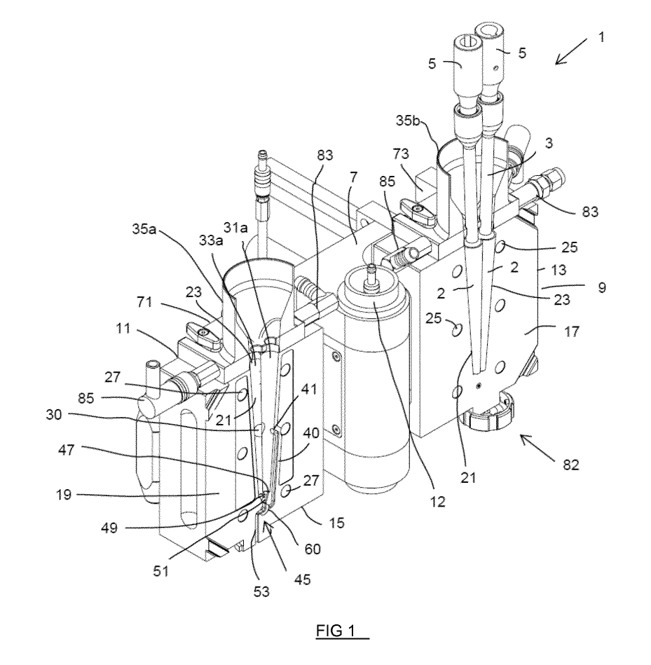

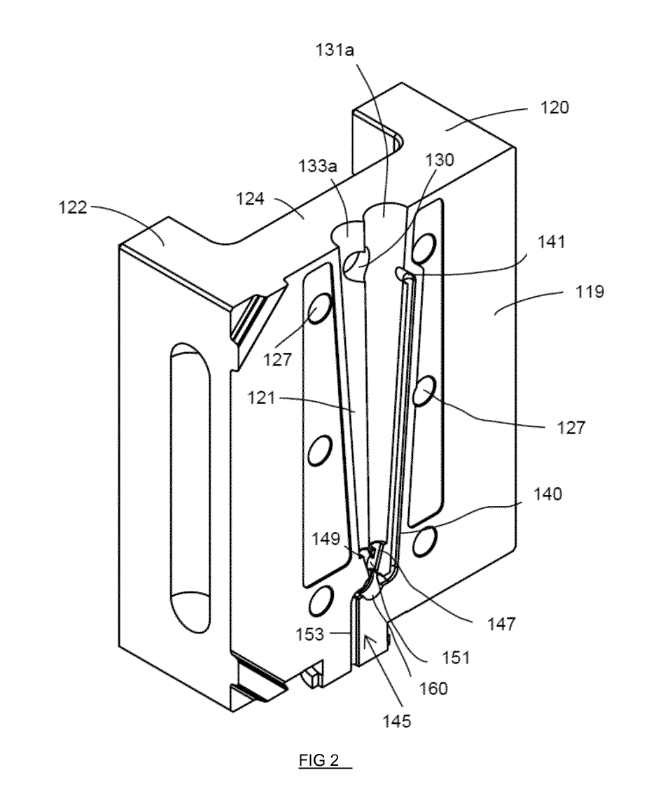

FIG. 1 shows a perspective view of part of a tabletop extruder according to the invention,

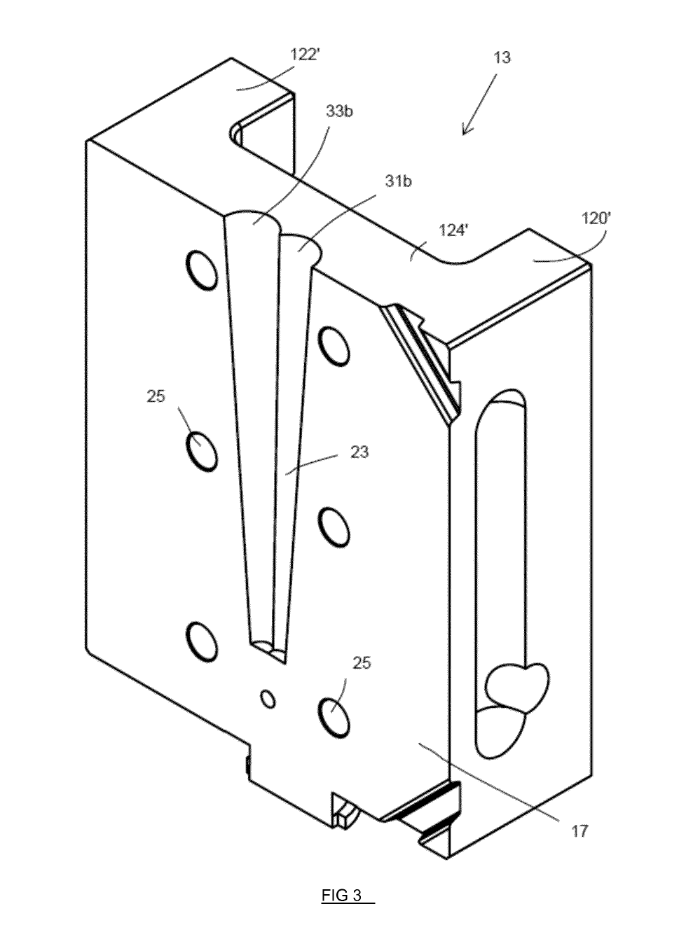

FIG. 2 show a perspective view of a first barrel liner of a tabletop extruder according to an embodiment of the invention,

FIG. 3 show a perspective view of a second barrel liner of a tabletop extruder according to an embodiment of the invention,

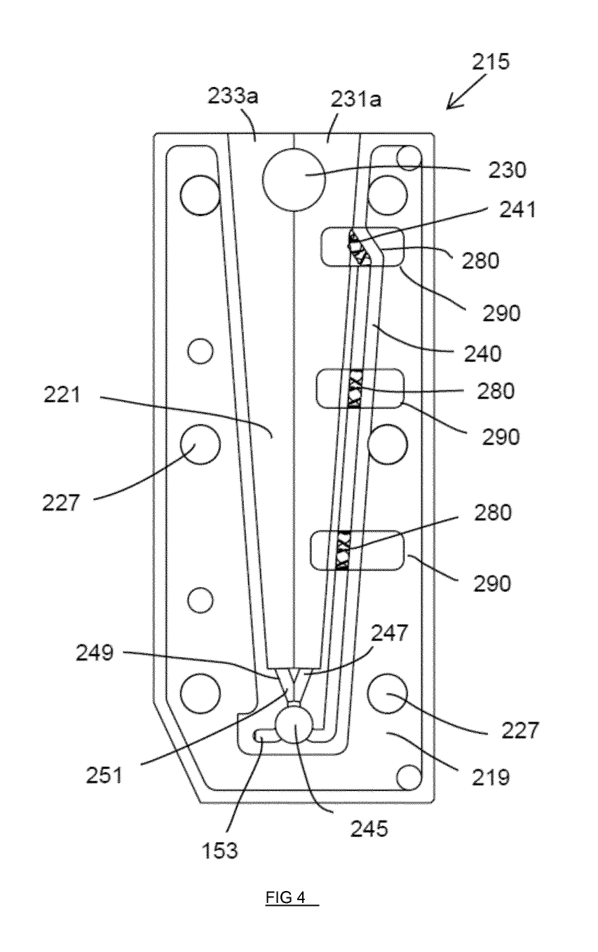

FIG. 4 shows a front view of an alternative embodiment of a first barrel liner of a tabletop extruder according to an embodiment of the invention,

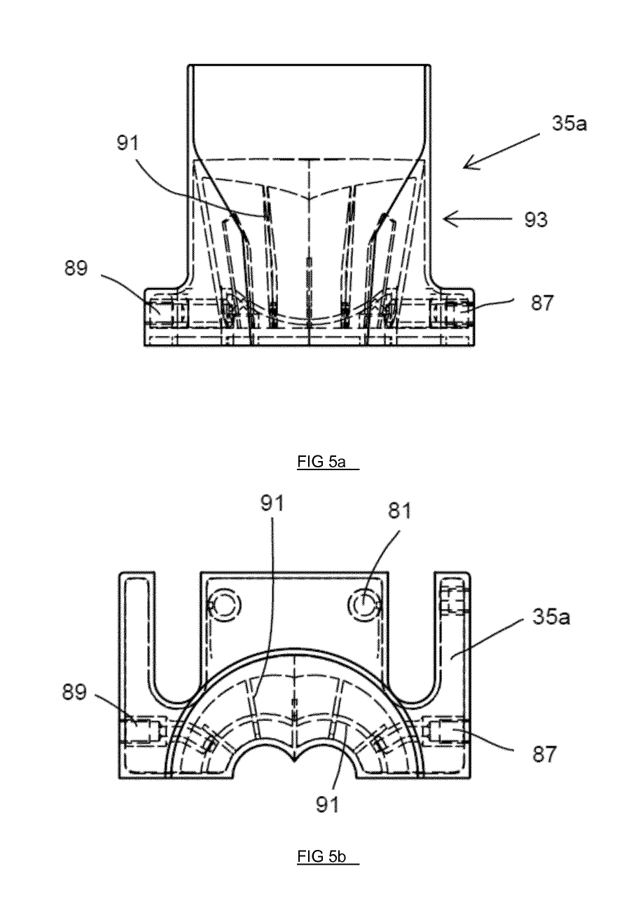

FIG. 5a, b show respectively a partially transparent side and a top view of a fluid cooled hopper halve of a tabletop extruder according to an embodiment of the invention,

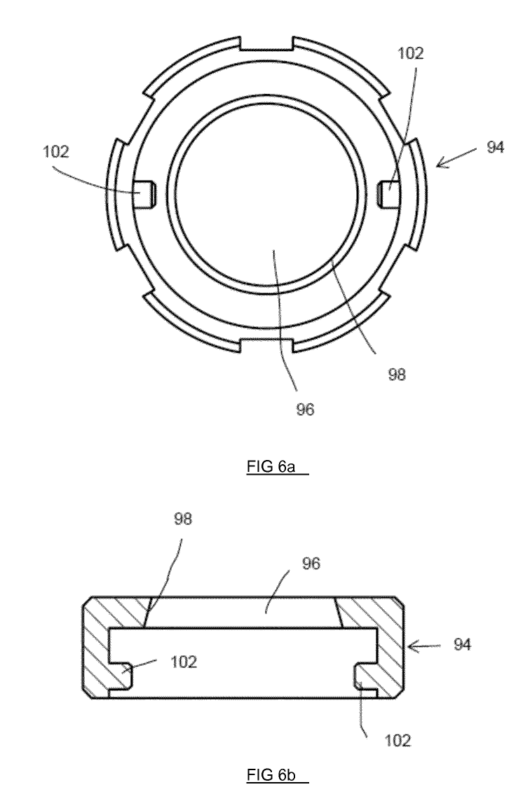

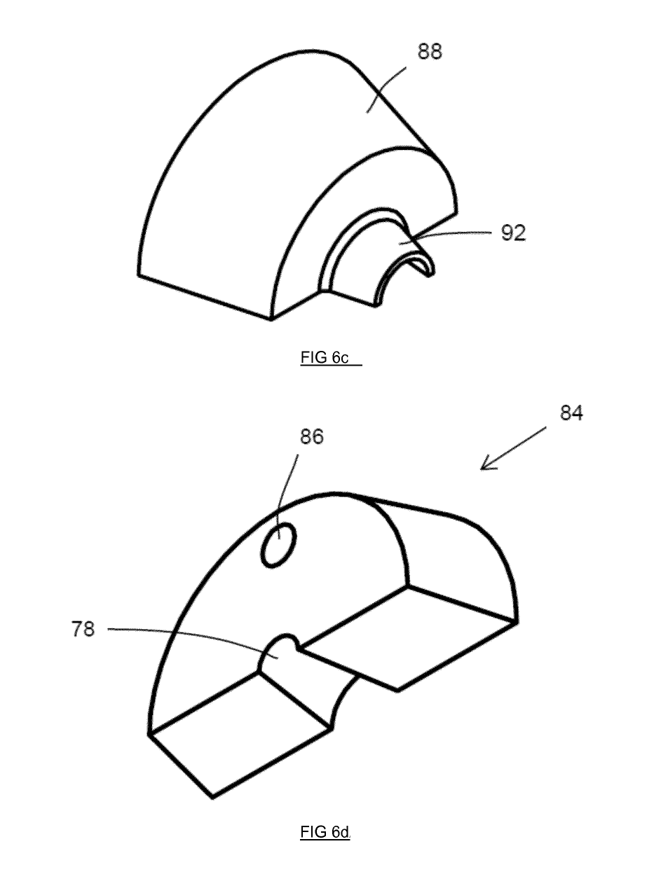

FIG. 6a-d show different views of components of a die coupling system to be coupled to a tabletop extruder according to an embodiment of the invention.

Like parts are indicated by the same numerals in the various figures.

Referring to the drawings in detail, and particularly FIG. 1, showing an extruder 1 according to the present invention for processing relatively small quantities of pharmaceutical and/or biomedical materials.

The extruder 1 comprises a pair of conical, co- or counter-rotating and intermeshing pair of extruder screws 3. The extruder screw geometry in sections 2 of the pair of extruder screws 3 is not shown in FIG. 1. The pair of extruder screws are coupled by coupling means 5 to a drive (not shown) for co- or counter-rotating the pair of extruder screws at adjustable speed (for example 1-500 rpm). By means of the coupling means 5 the extruder screws can be changed quickly for a different pair of extruder screws. The extruder 1 further comprises an extruder frame 7 and a barrel formed by a pair of separable housing blocks 9, 11. The housing blocks 9, 11 are shown in their open position in FIG. 1 and in use these housing blocks 9, 11 are positioned in a closed position (not shown) against each other. The housing blocks 9, 11 are pivotably connected to a shaft 12 of the extruder frame 7 for pivoting the housing blocks 9, 11 between an open position as shown in FIG. 1 to a closed position, in which position fastening means (not shown) such as bolts and or clamps can used to press housing blocks 9, 11 firmly against each other.

Each housing block 9, 11 comprises a barrel liner 13, 15. A side 17 of a first barrel liner 13 belonging to a first housing block 9 has a different configuration than a side 19 of a second barrel liner 15 belonging to a second housing block 11, which side 19 lies against side 17 in the closed position of the housing blocks 9, 11, among others side 19 of the second barrel liner comprises a feed opening 30. Each side 17, 19 has a pair of recesses 21, 23, which recesses 21, 23 in the closed position of the pair of separable housing blocks 9, 11 together define an interior conical volume (or more precisely, a double conical volume) for receiving a pair of conical extruder screws. The center lines of the recesses 21, 23 include a small acute angle with the vertical. Both sides 17, 19 further comprise through holes 25, 27 for bolts (not shown) for detachably connecting the housing blocks 9, 11 to each other in the closed position. The differences in the configuration of the sides 17, 19 are also shown in the FIGS. 2 and 3.

In one embodiment, the barrel liners of the pair of housing blocks is a mirror image of the other barrel liner of the pair of housing blocks (not shown). This allows for a simple design of the liners—particularly when use of recirculation and a tap in the discharge opening are not required.

In another embodiment, the barrel liners 13, 15 of the pair of housing blocks 9, 11 is different from a mirror image of the other barrel liner of the pair of housing blocks as shown in FIG. 1. This allows for a finely optimized design of the liners particularly when recirculation, a melt temperature sensor and/or a tap in the discharge opening are required.

In FIG. 2 an alternative barrel liner 115 is shown compared to the barrel liner 15 shown in FIG. 1. The barrel liner 115 only differs from barrel liner 15 in recirculation channel 40, 140 configuration and the position of the feed opening 30, 130 is different. The feed opening and/or said recirculation channel 40, 140, more in particular the exit 41, 141 thereof determines an effective extruder volume of the extruder according to the present invention. Barrel liner 15 has by means of the position of the feed opening and the length of the recirculation channel 40 a first effective extruder volume, whereas barrel liner 115 has an increased effective extruder volume by means of the more upstream position of the feed opening 130 the recirculation channel 140. The barrel liner 13 is identical to the barrel liner shown in FIG. 3 and therefore the same reference numbers have been used. The effective extruder volumes are for example 2 and 5 ml for FIGS. 1 and 2, respectively.

The extruder 1 according to the present invention can have different effective extruder volumes, by using different barrel liners comprising a feed opening 30, 130 at different locations. The feed opening can for example also be the opening through which the extruder screws enter the barrel; especially in case of a vertically operated extruder, and be provided with a hopper for feeding by gravity. By means of hopper 35a, 35b material can be fed into the interior conical volume via openings 31a, 33a. Alternatively, or in addition feed opening 30, 130 can be used, also optionally with the aid of a hopper and or feeder (not shown). In such case the feed opening 30,130 may be called a downstream or side feed opening; and material may be force fed by means of varying the location of the feed opening, only part of the extruder screw length—downstream of the feed opening—is effectively used for melting and mixing material. Thus, even for a certain fixed internal volume and extruder screw geometry, the effective extruder volume can still be simply varied by exchanging barrel liners. The non-used part of the extruder screw 3 does not need to have any profile for processing and/or transporting the material. It is even possible to provide a stop element (not shown)—also referred to as a backblocker—on the circumference of the extruder screw 3 to prevent any back mixing effects.

In the closed position the sides 17, 19 of barrel liners 13, 15 define an opening formed by opening halves 31a, 33a (131a, 133a for barrel liner 115), 31b, 33b. Through this opening the pair of extruder screws 3 enters into the interior volume (as shown in FIG. 1).

Further, the side 19, 119 of barrel liner 15, 115 define a discharge opening 45, 145. The discharge opening has two channels 47, 147, 49, 149 debouching in one collection channel 51, 151, an exit channel 53, 153. As indicated above barrel liners 15, 115 further comprise the recirculation channels 40, 140. Between the collection channel 51, the exit channel 53 and the recirculation channel 40, 140 the discharge opening 45, 145 comprises a tap 60, 160 for directing the flow of the melt. The tap 60, 160 is by means of a bar detachably mountable in the discharge opening and operable between a first position directing the material flow by means of an internal channel (not shown) through the exit channel 53, 153 or to a second position directing the material flow through the recirculation channel 40, 140. Alternatively, a 3-way tap may be used to allow semi-batch operation (not shown). The side 17 of the barrel liner 13 has a different configuration and does not have a discharge opening 45, 145 and a recirculation channel 40, 140. The side 17 of the barrel liner 13 preferably has a sensor (not shown) for measuring inline the melt temperature in the discharge opening 45, 145, more particular in its internal channel of the tap 60, 160. This inline measuring the melt temperature may be used to provide a reliable feedback on the conditions of the melt in or near the discharge opening 45, 145 and/or to control the heating and cooling of the housing block via the barrel base, including control the heating and cooling of the barrel liners and thus also of the melt. A very accurate temperature control of the melt can be obtained by controlling the heating and cooling of the barrel liners based on the measured actual melt temperature.

Each housing block 9, 11 further comprises a barrel base 71, 73 connected to the extruder frame 7, more in particular to the shaft 12. To each barrel base 71, 73 a barrel liner 13, 15, 115 of each housing block 9, 11 is detachably mounted. Here, the barrel liner is mounted by bolts, but other ways of mounting for example by other types of fasteners or by gravity is also feasible. The barrel liner 13, 15, 115 in FIGS. 2 and 3 is U-shaped and comprises two spaced apart legs that are connected to each other by a bridge part 124, 124′, wherein the legs of the U-shaped barrel liner are formed by two outer walls 120, 120′, 122, 122′. Between said outer walls 120, 120′, 122, 122′ at least partly the barrel base is positioned as the barrel liner 13, 115 is mounted to the barrel base 71, 73.

The U-shaped configured barrel liners 13, 15, 115 are preferred as they can easily be mounted precisely to the barrel bases 71, 73, as opposing outer walls of the barrel base 71, 73 slide into the opening provided by the two outer walls 120, 120′, 122, 122′ of the barrel liner 13, 15, 115a and over the sides of the legs/outer walls of the barrel liner facing each other. Further, an automatic alignment in two directions occurs during such mounting of the barrel liner to the barrel base. After demounting, the U-shaped configured barrel liners can be cleaned or sterilized easily and relatively quickly, as the U shaped barrel liner does not have any difficult accessible corners. By using fasteners like bolts, screws, hooks or other locking structures the barrel liner 15 having a first effective extruder volume (2 ml) and used for processing a first batch of pharmaceutical or biomedical materials can be exchanged in a fast and reliable manner for another barrel liner 115 having a second effective extruder volume (5 ml) larger than the first effective extruder volume. By quickly changing the barrel liners there is minimal delay and if the second batch has different materials, the risks of cross-contamination are minimized and even excluded as the extruder screws, the tap, the hopper 35a, 35b and the die 82 are also changed. As the delay for changing barrel liners is minimized the extruder has a relatively high effective capacity and is able to process a large number of samples in a certain period. For micro-extruders/tabletop extruders the quantities of materials to be processed are relatively small, and the effects of cross-contamination by a fixed amount of material are likely to have a major effect for the samples to be produced.

Preferably, each barrel base 71, 73 has heating and/or cooling capability for controlling the temperature of the material to be processed in extruder. In the U-shaped barrel liner 13, 15, 115 the contact surface between barrel liner and barrel base is relatively large, which is beneficial for heat transfer, making a fast and accurate control of the temperature by means of heating and or cooling unit (not shown) in the barrel base 71, 73 possible.

Although the drawings show a U-shaped barrel liner 13, 15, 115 only, it is emphasized that the invention also encompass embodiments utilizing other shapes of the barrel liner including for example L-shaped, C-shaped, E-shaped, and I-shaped barrel liners. An L-shaped barrel liner may for example be realized by omitting one outer wall of the U-shaped barrel liner 13, 15, 115, such that a part of one outer wall extending from the largest backside part of the barrel liner at least partly covers an outer wall of the barrel base as the barrel liner is mounted to the barrel base.

Instead of or in addition to the use of bolts for detachably mounting a barrel base 71, 73 to a barrel liner 13, 15, 115 of each housing block 9, 11 as indicated above, it is more preferred to use at least one hook (not shown) and guiding and locking means (not shown) for guiding and locking the hook automatically.

Said hook can be positioned on the barrel base and the guiding and locking means can be positioned on a side of the barrel liner directed to the barrel base, or vice versa. By means of the hook and the locking means not only a detachable connection can be provided, but the guiding means for receiving and guiding the hook also aligns the barrel base relatively to the barrel liner. By means of the hook and the guiding and locking means a fast, easy operator friendly, reproducible and reliable coupling is provided. Each barrel base 71, 73 has preferably two hooks, that cooperate with two notches (not shown) made in the sides of the legs of the U-shaped barrel liner facing to each other. In this way it is possible for an operator to suspend a barrel liner to the barrel base. The notches define a passage to a locking end position in the notches. By means of the passages the hooks are guided to the locking end position in the notches.

In FIG. 4 a second alternative barrel liner 215, compared to the barrel liners 15, 115 shown in FIGS. 1 and 2, is (partly) shown. The barrel liner 215 also provides an effective extruder volume of about 5 ml and the barrel liner 215 only differs from barrel liner 115 in that in the recirculation channel 240 static mixers 280 are provided. All other corresponding features have the same reference numbers, and these reference numbers are only raised with 100 compared to the reference numbers used for barrel liner 115 shown in FIG. 2.

Using said static mixer element 280 in the recirculation channel 240 can reduce the processing time of the extruder 1 according to the present invention considerable. Preferably, the static mixer element is an insert 290 that is detachably connected into the recirculation channel 240 for example by means of a snap in construction (not shown). This provides a flexible barrel liner 215 in which it is possible dependable on the material to be processed to use a static mixer or not. By providing sufficient inserts 290 an operator does no longer have to wait to use the extruder until a previous used insert 290 has been cleaned/sterilized. It is also possible to provide inserts without static mixing capabilities (not shown). In addition, disposable static mixer inserts may be used.

It is preferred that a hopper is arranged on top of the housing. One embodiment of the invention has a hopper as shown in more detail in FIGS. 5a and 5b. Here, the hopper 35a, 35b consists of two connectable halves 35a, 35b, wherein each halve is connected to the barrel base 71, 73 by fasteners such as bolts (not shown) inserted in through holes 81 or by other types of fasteners or other connectors. The hopper 35a, 35b is preferably actively cooled and/or insulated from the housing of the extruder. The hopper may comprise rapid couplings (FIG. 1, 83, 85) connectable to an inlet 87 and an outlet 89 between which a network inside the hopper of relatively small dimensioned channels 91 is provided for cooling by means of fluid, e.g. water or air, of the funnel shaped part 93 of the hopper 35a,b and/or the hopper base. The advantage of having a cooled hopper is that powder mixtures introduced in the hopper will not weaken and/or (partially) melt and then stick to the hopper wall or extruder screw(s), which sticking may prevent a proper filling of the extruder and may even lead to deviation from the intended concentration in the formulation due to selective sticking. In FIG. 5, the hopper consists of two halves 35a, 35b which facilitate easy cleaning and/or sterilizing of the hopper. Further, it is easy to change the hopper halves 35a, 35b for another pair of hopper halves and the extruding material may be delivered directly and evenly to the extruder screw during use while extruder screws and hopper may yet easily be dismounted for example for cleaning. In a preferred embodiment of the extruder, the hopper is arranged directly above the housing of the extruder with the extruder screw(s) or the extruder screw shafts protruding through the hopper. Particularly if was found to be advantageous when the extruder screw is a twin screw with screw section extending into the hopper and the screw section extending into the hopper is a intermeshing pair of screws as this allow for a self-cleaning effect of the screw reducing the effect sticking extrusion material. An embodiment with a combination of the cooled hopper, intermeshing twin screws and extruder screws extending into the hopper was found particularly advantageous in handling of difficult to feed samples such as fluffy and/or static charging powders.

Such hopper suited for handling small amounts of powdery, fluffy and/or sticky material comprises preferably a series of cooling channels for effectively cooling the hopper and material contained therein, to prevent premature (partial) melting, and sticking or agglomeration of particles. It was found to be advantageous that the hopper is manufactured by Direct Metal Laser Sintering as this allowed for preparing the hopper of sufficiently small size and dimension, in particular wall thickness and internal channels. Direct Metal Laser Sintering is also referred to as selective laser sintering (SLS) or selective laser melting (SLM) techniques. As for other parts, the hopper is preferably made from stainless steel.

FIGS. 6a-d show different views of examples of components of a die coupling system 82 which is also shown in the tabletop extruder 1 shown in FIG. 1. An exit of the extruder 1 is formed by a die of which a first halve 84 is shown in FIG. 6d. The die consists of two identically shaped halves 84 forming together a massive truncated cone with an outlet 78 for shaping the material. In at least one halve an arresting opening 86 is provided. The die halves 84 are detachably mountable in a hollow truncated cone component 88 as shown in FIG. 6c. Said hollow truncated cone component 88 comprises an exit 92 and at least one pin (not shown) to be arrested in the arresting opening 86. The die coupling system further comprises a quick detachable coupling, preferably a bayonet ring 94 as shown in FIGS. 6a and 6d. The hollow truncated cone component 88 supporting the die halves 84 therein is positioned in opening 96 of the bayonet ring 94. Said opening has a conical edge 98 for carrying the hollow truncated cone component 88. The extruder 1 is also provided with female receptors, like slots (not shown) for receiving and capturing the male parts, i.e. pins 102 of the bayonet ring 94 for coupling the die with the extruder 1.

Although, it is possible to manufacture the die 84 and the truncated cone 88 as a whole, for cleaning and/or sterilization purposes it is advantageous to provide these components in halves.

Instead of a die as discussed above it is also possible to provide a mould for forming the exit of the extruder.

Although not shown in the figures the dimensions of the interior volume of a first pair of barrel liners may be different from the dimensions of the interior volume of a second pair of barrel liners, i.e. by making the grooves for example deeper or wider (or less deeper and less wider), for varying an effective extruder volume of the extruder in the closed position starting from 1 to 50 ml, preferably from 1 to 20 ml.

For processing pharmaceutical and/or biomedical materials with the extruder of the present invention, the extruder parts in contact with the material are preferably manufactured from inert and low abrasive materials, like ceramics, stainless metals, like titanium or a stainless steel, preferably according to DIN 1.4112. Such stainless steel parts preferably have a smoothened surface; to improve contacting of surfaces of parts being mounted together, and to improve cleanability. Surface roughness Ra is preferably less than 1.0 micrometre (μm), more preferably less than 0.8, 0.5, 0.4, 0.3, or 0.2 μm.

Although the drawings show a vertical (flow) extruder the main principles of the invention as specified in the claims and the description are also similarly applicable in a horizontal (flow) extruder.

The invention further concerns an extruder for processing relatively small quantities of material, preferably pharmaceutical and/or biomedical materials, which extruder comprises an extruder frame, a barrel, at least one extruder screw, and a drive for rotating the at least one extruder screw, wherein the barrel is formed by a pair of separable housing blocks that are positioned in a closed position against each other during processing, wherein in the closed position the pair of separable housing blocks define an interior volume, a feed opening, a discharge opening and an opening for receiving the at least one extruder screw in the interior volume, wherein the barrel comprises at least one recirculation channel, wherein the at least one recirculation channel comprises at least one static mixer element. Preferably this static mixer element is a detachably mountable insert in the at least one recirculation channel. For controlling the (static) mixing properties it is also possible to use inserts having no static mixing capabilities. In this way a flexible extruder is provided.

The invention further concerns an extruder for processing relatively small quantities of material, preferably pharmaceutical and/or biomedical materials, which extruder comprises an extruder frame, a barrel, at least one extruder screw, and a drive for rotating the at least one extruder screw, wherein the barrel is formed by a pair of separable housing blocks that are positioned in a closed position against each other during mixing, wherein in the closed position the pair of separable housing blocks define an interior volume, a feed opening, a discharge opening and an opening for receiving the at least one extruder screw in the interior volume, wherein an exit of the extruder is formed by a die detachably mountable to the extruder by means of a quick detachable coupling, preferably a bayonet ring. Preferably, the die comprises two connectable halves.

The invention further concerns an extruder for processing relatively small quantities of material, preferably pharmaceutical and/or biomedical materials, which extruder comprises an extruder frame, a barrel, at least one extruder screw, and a drive for rotating the at least one extruder screw, wherein the barrel is formed by a pair of separable housing blocks that are positioned in a closed position against each other during processing, wherein in the closed position the pair of separable housing blocks define an interior volume, a feed opening, a discharge opening and an opening for receiving the at least one extruder screw in the interior volume, wherein the extruder comprises a cooled hopper consisting of two connectable halves. Preferably, said cooled hopper comprises internal cooling channels, and is made by Direct Metal Laser Sintering.

The invention further concerns an extruder for processing relatively small quantities of material, preferably pharmaceutical and/or biomedical materials, which extruder comprises an extruder frame, a barrel, at least one extruder screw, and a drive for rotating the at least one extruder screw, wherein the barrel is formed by a pair of separable housing blocks that are positioned in a closed position against each other during processing, wherein in the closed position the pair of separable housing blocks define an interior volume, a feed opening, a discharge opening and an opening for receiving the at least one extruder screw in the interior volume, wherein the discharge opening comprises a tap that by means of a bar is detachably mountable in the discharge opening and operable between a closed and a open position.

The invention further concerns an extruder for processing relatively small quantities of material, preferably pharmaceutical and/or biomedical materials, which extruder comprises an extruder frame, a barrel, at least one extruder screw, and a drive for rotating the at least one extruder screw, wherein the barrel is formed by a pair of separable housing blocks that are positioned in a closed position against each other during processing, wherein in the closed position the pair of separable housing blocks define an interior volume, a feed opening, a discharge opening and an opening for receiving the at least one extruder screw in the interior volume, wherein the feed opening is defined by at least one barrel liner, wherein the at least one barrel liner is exchangeable with at least one other barrel liner, which other barrel liner defines the feed opening at a different location, to result in a different effective extruder volume.

1. An extruder for processing relatively small quantities of material, preferably pharmaceutical and/or biomedical materials, which extruder comprises an extruder frame, a barrel, at least one extruder screw, and a drive for rotating the at least one extruder screw, wherein the barrel is formed by a pair of separable housing blocks that are positioned in a closed position against each other during processing, wherein in the closed position the pair of separable housing blocks define an interior volume, a feed opening, a discharge opening and an opening for receiving the at least one extruder screw in the interior volume, characterized in that each housing block comprises a barrel base and a barrel liner, wherein the barrel base is connected to the extruder frame, to which barrel base the barrel liner is detachably mountable, and wherein at least a part of one outer wall of the barrel liner at least partly covers an outer wall of the barrel base as the barrel liner is mounted to the barrel base.

2. Extruder according to claim 1, wherein the barrel liner is U-shaped comprising two spaced apart legs that are connected to each other by a bridge part, wherein the legs of the U-shaped barrel liner are formed by two outer walls between which the barrel base is positioned at least partly as the barrel liner is mounted to the barrel base.

3. Extruder according to claim 1, wherein the barrel liner is detachable mountable to the barrel base by fasteners, preferably the fasteners comprise at least one hook and guiding and locking means for guiding and locking the hook.

4. Extruder according to claim 1, wherein the feed opening is defined by at least one barrel liner, wherein the at least one barrel liner is exchangeable with at least one other barrel liner, which other barrel liner defines the feed opening at a different location.

5. Extruder according to claim 1, wherein at least one barrel liner comprises at least one recirculation channel, and wherein the at least one recirculation channel preferably comprises at least one static mixer element.

6. Extruder according to claim 1, wherein the dimensions of the interior volume of said pair of housing blocks—each housing block comprising said barrel base and said barrel liner—differs from the dimensions of a further interior volume of a further pair of housing blocks—each further housing block comprising said barrel base and a further barrel liner.

7. Extruder according to claim 1, wherein the at least one extruder screw is a pair of extruder screws, preferably a conical, co- or counter-rotating and intermeshing pair of extruder screws.

8. Extruder according to claim 1, wherein at least the barrel liners and extruder screw(s) have a surface roughness Ra of less than 0.4 micrometre.

9. Extruder according to claim 1, wherein the extruder comprises a cooled hopper consisting of two connectable halves, preferably the extruder screws extend into the hopper, more preferably the extruder screws are an intermeshing and/or self-cleaning pair of twin screws.

10. Extruder according to claim 1, wherein an exit of the extruder is formed by a die detachably mountable to the extruder by means of a quick detachable coupling, preferably a bayonet ring.

11. Extruder according to claim 10, wherein the die comprises two halves that are positioned in a truncated cone, which truncated cone is positioned in the bayonet ring to be coupled with the exit of the extruder.

12. Extruder according to claim 1, wherein the discharge opening comprises a tap in the discharge opening and operable between a closed and an open position, preferably the tap is detachable from the discharge opening.

13. Extruder according to claim 1, wherein each barrel base has heating and/or cooling capability.

14. Extruder according to claim 1, wherein at least one barrel liner comprises a sensor for measuring the inline melt temperature near or in the discharge opening.

15. Extruder according to claim 1, wherein each barrel liner of the pair of housing blocks is a mirror image of the other barrel liner of the pair of housing blocks.

16. Extruder according to claim 1 wherein each barrel liner of the pair of housing blocks is different from a mirror image of the other barrel liner of the pair of housing blocks.

17. Use of an extruder according to claim 1 for extruding material on a laboratory scale, preferably for extrusion of a sample available in an amount of less than 100 gram, more preferably for extrusion of a pharmaceutical and/or a biomedical material or composition.

18. Use of an extruder according to claim 1 for manufacturing of medical products, preferably for manufacturing of personalized medicine.

19. A method of operating an extruder according to claim 1 comprising the steps of
extrude a first material
remove barrel liners from the pair of housing blocks,
clean barrel liners,
optionally sterilize barrel liners
attach cleaned barrel liners to the barrel bases, and
extrude a second material.

20. A method of operating an extruder according to claim 1 comprising the steps of
extrude a first material
remove barrel liners from the pair of housing blocks,
attach a further set of barrel liners to the barrel bases, and
extrude a second material.
